(19) United States
(12) Patent Application Publication
(10) Pub. No.: US 2014/0126262 A1
(43) Pub. Date: May 8, 2014

(54) INVERTER CIRCUIT

(71) Applicants: Yuancheng Lu, Shanghai (CN); Weibi Hong, Shanghai (CN)

(72) Inventors: Yuancheng Lu, Shanghai (CN); Weibi Hong, Shanghai (CN)

(73) Assignee: New Focus Lighting & Power Technology (Shanghai) Co., Ltd., Shanghai (CN)

(21) Appl. No.: 14/130,094

(22) PCT Filed: Jul. 15, 2011
(86) PCT No.: PCT/CN2011/077193

§ 371 Date: Dec. 30, 2013

(30) Foreign Application Priority Data
Jun. 30, 2011 (CN) 201110182169.X

(51) Int. Cl. H02M 7/217

(52) U.S. Cl. CPC H02M 7/217
USPC 363/131

(57) ABSTRACT

An inverter circuit includes a DC-AC inverter, a sampling circuit, a voltage-current conversion circuit, an isolation circuit and an electronic starter switch. The sampling circuit includes a first and a second diode connected in parallel and opposite in polarity. A forward voltage drop at the first diode blocks the conductance of a first transistor of the voltage-current conversion circuit when there is no load, and a forward voltage drop at the second diode turns on the first transistor when there is a load. The connection of the first and second diodes to a second AC output terminal of the DC-AC inverter nearly has no impact on the AC output of the inverter circuit. These enable the inverter circuit to have low power consumption when there is no load and to be immediately activated upon connection of a load, thereby achieving detection of a load smaller than 0.1 W.

### TECHNICAL FIELD

The present invention relates generally to inverter circuits. In particular, the invention relates to an inverter circuit capable of small load detection with low standby power consumption.

### BACKGROUND

As a kind of power semiconductor device, an inverter is a static current-converting apparatus capable of converting direct current (DC) electric power produced by batteries, fuel cells or solar cells into constant-voltage (e.g., 220 V or 115 V) constant-frequency (e.g., 50 Hz, 60 Hz, or 400 Hz) alternating current (AC) electric power which is thereafter supplied to AC loads or connected to an AC grid. Such technology of current conversion plays a crucial role in the development of new energy.

In its application as a DC-AC inverter power supply with a DC voltage input and an AC voltage output, the DC voltage is typically supplied by a DC battery. When a load is connected to the AC output terminal, the inverter works to convert the input DC voltage into an AC voltage and supplies the load with the AC voltage. However, in this design, the inverter still works even when there is no load connected, which causes a certain rate of static power consumption. Moreover, power is continuously consumed from the battery, which can contribute a great unnecessary power loss.

One efficient approach to reduce this unnecessary power loss is to render the inverter in a standby state when there is no load connected. To achieve this, a circuit for detecting whether there is a load connected is further needed to be arranged. Currently, the most commonly adopted detecting method is to use a sampling resistor or a current transformer to check the output current of the inverter. However, the above-mentioned method suffers from two major drawbacks as follows: 1) when the load connected is small, a wrong judgment that there is no load is connected will be made and the inverter is hence rendered in a standby state, thus leading to unsuitability for small load applications; and 2) the inverter of this method is generally required to have a power consumption of greater than 1.5 W even when in a standby state, otherwise it cannot be activated when a load is connected, and therefore it is impossible for this kind of inverter to achieve a lower standby power consumption.

In conclusion, existing inverter is likely to judge a small load as no load when detecting whether there is a load connected, as a result, the existing inverter is frequently lead into a standby state by error, thus leading to unsuitability for small load applications and a high standby power consumption. Therefore, there exists a need for an improved method to address these problems.

### SUMMARY OF THE INVENTION

The present invention addresses the drawbacks of the prior art by presenting an inverter circuit which is capable of the detection of a small load that is smaller than 0.1 W and has a standby power consumption of lower than 0.1 W.

The above objectives are attained by an inverter circuit including:

a DC-AC inverter having a first DC input terminal, a second DC input terminal, a first AC output terminal and a second AC output terminal, the first AC output terminal being connected, via a fifth resistor, to a high DC voltage with respect to a ground (G) point, the first AC output terminal being configured to generate a detection current for indicating whether there is a load when there is no AC output;

a sampling circuit connected to the second AC output terminal for converting a load current to a sampling voltage and output the sampling voltage when there is a load connected between the first AC output terminal and the second AC output terminal;

a voltage-current conversion circuit connected to the sampling circuit for converting the sampling voltage to an optocoupler driving current;

an isolation circuit connected to the voltage-current conversion circuit for isolating a DC input component from an AC output component of the inverter circuit and for generating a starting voltage driven by the optocoupler driving current; and

an electronic starter switch connected to each of the first DC input terminal, the isolation circuit and the voltage-current conversion circuit for controlling an on/off state of the DC-AC inverter under control of the starting voltage.

Further, the sampling circuit may include a first diode, a second diode, a first resistor, a third diode and a DC-DC converter power supply. The first diode and the second diode are connected in parallel and opposite in polarity to each other and both of the first diode and the second diode are connected to the second AC output terminal. The third diode and the first resistor are connected in series between a low DC voltage and the G point. A node between the third diode and the first resistor is connected to an anode of the first diode, and an anode of the second diode generates the sampling voltage.

Further, the voltage-current conversion circuit may include a first transistor, a second resistor and a third resistor, and the anode of the second diode is connected to a first base of the first transistor via the second resistor, such that the first transistor is turned on when the sampling voltage is generated, and a first emitter of the first transistor is connected to the isolation circuit via the third resistor to receive the optocoupler driving current.

Further, a second capacitor may be connected in parallel to the third diode to stabilize a voltage of the third diode.

Alternatively, the sampling circuit may include a first diode, a second diode, a sixth resistor, a seventh resistor and an eighth resistor. The first diode and the second diode are connected in parallel and opposite in polarity to each other and both of the first diode and the second diode are connected to the second AC output terminal. The sixth resistor is connected between an anode of the second diode and the G point, and the anode of the second diode is connected to the voltage-current conversion circuit. The seventh resistor and the eighth resistor are connected in series between a low DC voltage and the G point, and a node between the seventh resistor and the eighth resistor is connected to both of an anode of the first diode and the voltage-current conversion circuit. Moreover, the voltage-current conversion circuit may include an analog amplifier and a third resistor. The analog amplifier is connected between the low DC voltage and the G point, and the analog amplifier has a positive input terminal connected to the anode of the second diode, a negative input terminal connected to the node between the seventh resistor and the eighth resistor, and an output terminal connected to the isolation circuit via the third resistor.

Alternatively, the sampling circuit may include a seventh resistor, an eighth resistor and a sampling resistor. The sampling resistor has a first end which is connected to the load connecting to the voltage-current conversion circuit and a second end which is connected to the second AC output terminal connecting to the G point, wherein the seventh resistor and the eighth resistor are connected in series between a low DC voltage and the G point, and wherein a node between the seventh resistor and the eighth resistor is connected to the voltage-current conversion circuit. Moreover, the voltage-current conversion circuit may include an analog amplifier and a third resistor. The analog amplifier is connected between the low DC voltage and the G point, and the analog amplifier has a positive input terminal connected to the sampling resistor, a negative input terminal connected to the node between the seventh resistor and the eighth resistor and an output terminal connected to the isolation circuit via the third resistor.

Further, both of the high DC voltage and the low DC voltage may be generated by a DC-DC converter power supply. The DC-DC converter power supply may be an isolated micro-power converter power supply having a first input terminal, a second input terminal, a first output terminal and a second output terminal, wherein the first output terminal outputs the high DC voltage and the second output terminal outputs the low DC voltage.

Further, the first output terminal outputs a high DC voltage of higher than +100 V, and wherein the second output terminal outputs a low DC voltage of +5 V to +15 V.

Further, a second switch may be arranged at the first input terminal of the DC-DC converter power supply for disabling a load detection function when there is no need therefor.

Further, the DC-DC converter power supply may have a DC input power of lower than 0.1 W when there is no load.

Further, the isolation circuit may include an optocoupler having a first end connected to the voltage-current conversion circuit and a second end connected between the electronic starter switch and the second DC input terminal, such that when the optocoupler driving current is received at the first end, the second end conducts and generates the starting voltage.

Further, the electronic starter switch may include a second transistor having a second base connected to the isolation circuit, a second emitter connected to the first DC input terminal and a second collector connected to the DC-AC inverter.

Further, the second base of the second transistor is connected to the isolation circuit via a fourth resistor.

Further, a first capacitor may be connected in parallel to the isolation circuit and between the electronic starter switch and the second DC input terminal to stabilize an operation of the electronic starter switch.

Further, a first switch may be arranged at the input terminal of the DC-AC inverter for enabling the DC-AC inverter to be manually turned on when the load detection function is disabled.

Compared with the prior art, the inverter circuit of the present invention employs a pair of diodes D1 and D2 connected in parallel and opposite in polarity to each other, such that when there is no load, a forward voltage drop provided by the first diode D1 blocks the conductance of the first transistor T1 or the analog amplifier, and when there is a load, the first transistor T1 is turned on due to a forward voltage drop provided by the second diode D2. Moreover, the connection of the first diode D1 and the second diode D2 that are connected opposite in polarity to each other to the second AC output terminal of the DC-AC inverter nearly has no impact on the AC output of the DC-AC inverter. These enable the inverter circuit to have low power consumption (as low as 0.1 W) and to be immediately activated as soon as a load (even smaller than 0.1 W) is connected and to achieve the objective of small load detection when the load is smaller than 0.1 W.

### BRIEF DESCRIPTION OF THE DRAWINGS

FIG. 1 is a schematic illustrating an inverter circuit in accordance with a first preferred embodiment of the present invention.

FIG. 2 depicts a circuit schematic of an embodiment of a DC-DC converter power supply employed in the first preferred embodiment of the present invention.

FIG. 3 is a schematic illustrating an inverter circuit in accordance with a second preferred embodiment of the present invention.

FIG. 4 is a schematic illustrating an inverter circuit in accordance with a third preferred embodiment of the present invention.

### DETAILED DESCRIPTION

To further describe the present invention, reference is made to the following detailed description on example embodiments, taken in conjunction with the accompanying drawings. Other advantages and beneficial effects of the invention will become readily apparent to those skilled in the art upon reading the following description. Moreover, the invention may be embodied or used in many different forms from the exemplary ones and various modifications and variations can be made to details of the exemplary ones based on different perspectives and applications without departing from the present teachings.

FIG. 1 shows an inverter circuit according to a first preferred embodiment of the present invention. As shown in FIG. 1, the inverter circuit is used to convert a DC input voltage (DC) to an AC output voltage (AC), which includes a DC-AC inverter 101, a sampling circuit 102, a voltage-current conversion circuit 103, an isolation circuit 104 and an electronic starter switch 105.

The DC-AC inverter 101 may be an isolated or a non-isolated micro-power inverter power supply having two input terminals (a first DC input terminal DC+ and a second DC input terminal DC−) and two output terminals (a first AC output terminal AC1 and a second AC output terminal AC2). The first and second AC output terminals AC1 and AC2 are provided for connecting a load L1 therebetween. The first AC output terminal AC1 is connected, via a fifth resistor G5, to a high DC voltage +HV with respect to a G point (which is a ground point in this preferred embodiment). The DC-AC inverter 101 is configured to convert an input voltage DC to an output voltage AC and preferably, a first switch S1 may be arranged at the input terminal of the DC-AC inverter 101, such that the DC-AC inverter 101 works when the first switch S1 is closed and stops working when the first switch S1 is open. The sampling circuit 102 is connected to the second AC output terminal AC2 and configured to convert, when there is a load between the first and second AC output terminals AC1 and AC2, a load current (generated by the +HV when there is no AC output) into a sampling voltage, output the sampling voltage, and prevent the generation of the sampling voltage when there is no load between the first and second AC output terminals AC1, AC2. The voltage-current conversion circuit 103 is connected to the output terminal of the sampling circuit 102 and configured to convert the sampling voltage output by the sampling circuit 102 into an optocoupler driving current. The isolation circuit 104 is connected between a low DC voltage +V and the voltage-current conversion circuit 103, thereby working under the control of the optocoupler driving current to generate a starting voltage. The isolation circuit 104 is also configured to isolate a DC input component from an AC output component of the inverter circuit of the present invention. The electronic starter switch 105 is connected to the first DC input terminal DC+ for connecting the DC input voltage DC to the input terminal of the DC-AC inverter 101 and controlling the on/off state of the DC-AC inverter 101 when the first switch S1 is open.

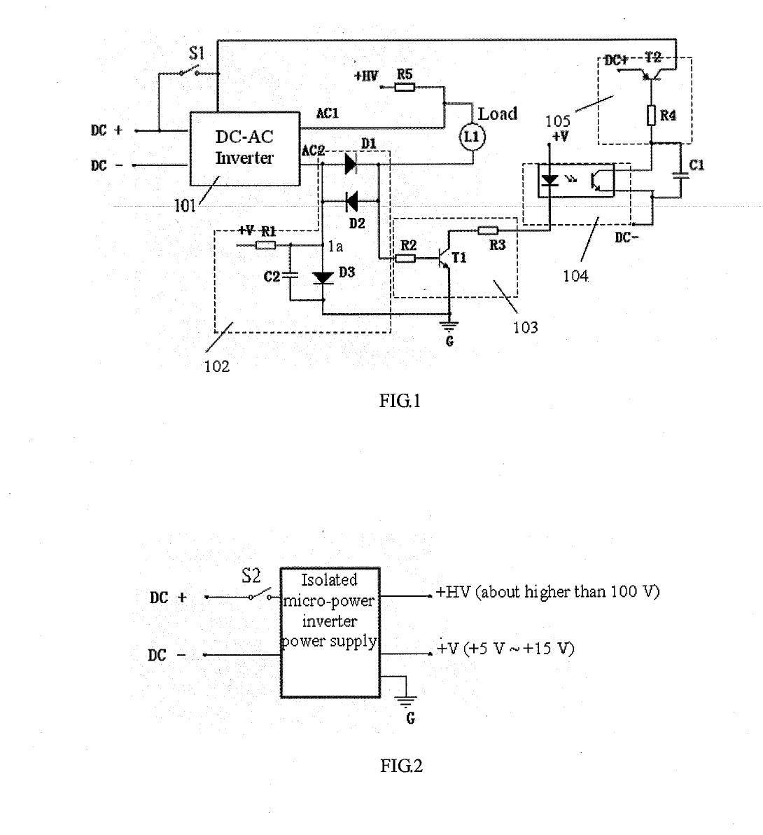

Stated more specifically, in the first preferred embodiment of the present invention, the sampling circuit 102 includes a first diode D1, a second diode D2, a first resistor R1 and a third diode D3. The first diode D1 and the second diode D2 are connected in parallel and opposite in polarity to each other, and both of the first diode and the second diodes are connected to the second AC output terminal AC2. The third diode D3 and the first resistor R1 are connected in series between the low DC voltage +V and the G point. In this first preferred embodiment of the present invention, both of the low DC voltage +V and the high DC voltage +HV are generated by a DC-DC converter power supply. FIG. 2 depicts a circuit schematic of the DC-DC converter power supply of the first preferred embodiment of the present invention. The DC-DC converter power supply is an isolated micro-power converter power supply having two input terminals (a first input terminal and a second input terminal) and two output terminals (a first output terminal and a second output terminal +V). Wherein, the first output terminal outputs the high DC voltage +HV of about higher than 100 V, and the second output terminal outputs the low DC voltage +V of about +5 V to +15 V. It is noted that when the first and second output terminals of the DC-DC converter power supply output a current that is not supplied to any load (i.e., there is no load connected to the AC output terminal), a DC input power of the DC-DC converter power supply can be controlled to be lower than 0.1 W. The third diode D3 and the first resistor R1 are connected in series between the second output terminal of the DC-DC converter power supply (i.e., the low DC voltage +V) and the G point, such that a first node 1a between the third diode D3 and the first resistor R1 gets a voltage of about 0.5 V. The first node 1a is further connected to an anode of the first diode D1 (or a cathode of the second diode D2), and an anode of the second diode D2 generates and outputs the sampling voltage. The voltage-current conversion circuit 103 includes a first transistor T1, a second resistor R2 and a third resistor R3. The anode of the second diode D2 is connected to a base of the first transistor T1 via the second resistor R2, such that the first transistor T1 can be turned on driven by the sampling voltage. A collector of the first transistor T1 receives the optocoupler driving current passing through the third resistor R3, and an emitter of the first transistor T1 is connected to the G point. The isolation circuit 104 includes an optocoupler having one end (i.e., the end corresponding the left side of FIG. 1) connected to the second output terminal +V of the DC-DC converter power supply and the voltage-current conversion circuit 103 and the other end (i.e., the end corresponding the right side of FIG. 1) connected between the electronic starter switch 105 and the second DC input terminal DC−, such that when the optocoupler driving current flows into the one end, the other end conducts and generates the starting voltage for controlling the electronic starter switch 105. The isolation circuit 104 is also configured to isolate a DC input component from an AC output component of the inverter circuit of the present invention. The electronic starter switch 105 includes a second transistor T2 having a base connected to the isolation circuit 104, an emitter connected to the first DC input terminal DC+ and a collector connected to the DC-AC inverter 101, such that when the starting voltage is applied to the base of the second transistor T2, the second transistor T2 is turned on and the DC-AC inverter 101 starts to work. Preferably, a fourth resistor R4 may be further connected between the isolation circuit 104 and the electronic starter switch 105.

In order to stabilize the on/off state of the second transistor T2, a first capacitor C1 may be arranged to connect in parallel to the optocoupler and between the electronic starter switch 105 and the second DC input terminal DC−. Moreover, in order to stabilize a voltage of the third diode D3 of the sampling circuit 102, a second capacitor C2 may be arranged to connect in parallel to the third diode D3.

Operating principle of the present invention will be further specified and described below by referring to FIG. 1. The low DC voltage +V output by the second output terminal of the DC-DC converter power supply passes through the first resistor R1 and the third diode D3 and provides the third diode D3 with a voltage of about 0.5 V. When there is no load, the second DC output terminal AC2 will have a voltage of 0.5 V with respect to the G point. Due to the voltage dropping effect of the first diode D1, the 0.5 V voltage is not high enough to simultaneously turn on both of the first diode D1 and the first transistor T1. Thus, the sampling voltage will not be generated at the base of the first transistor T1, the first transistor T1 will not be turned on, the optocoupler driving current will not be generated, the isolation circuit 104 will not generate the starting voltage, the second transistor T2 will be cut off, the electronic starter switch 105 will control the DC-AC inverter 101 to keep turned off, and thus the total power consumption of the whole system will be equal to that of the DC-DC converter power supply, which is 0.1 W. Otherwise, when a load is connected between the first and second output terminals AC1 and AC2, the 100 V high DC voltage +HV will generate a sampling voltage of about 1 V downstream to the load L1 as soon as the load is connected, thereby turning on the second diode D2 in forward bias. After that, the first transistor T1 is turned on and generates the optocoupler driving current which thereafter turns the optocoupler on. After the optocoupler generates the starting voltage, the starting voltage is applied to the base of the second transistor T2 and turns on the second transistor T2, thus connecting the DC voltage at the first DC input terminal DC+ to an input terminal of a control circuit of the DC-AC inverter 101 and activating the DC-AC inverter 101. After the DC-AC inverter 101 produces a stable AC output, the AC output turns the first transistor T1 on in its positive half-cycle, and the electricity stored in the first capacitor C1 will keep the second transistor T2 always turned on.

It is noted herein that in order to obtain the desirable results of the present invention, when the DC-AC inverter 101 is turned off, there should be a high resistance between the first and second AC output terminals AC1, AC2 to ensure a DC voltage of higher than 100 V for the first AC output terminal AC1 with respect to the G point.

Furthermore, in this first preferred embodiment of the present invention, a second switch S2 for turning off the whole system may be further arranged at the input terminal of the DC-DC converter power supply. That is, only when the second switch S2 is closed, the inverter circuit of the present invention is rendered in a standby state.

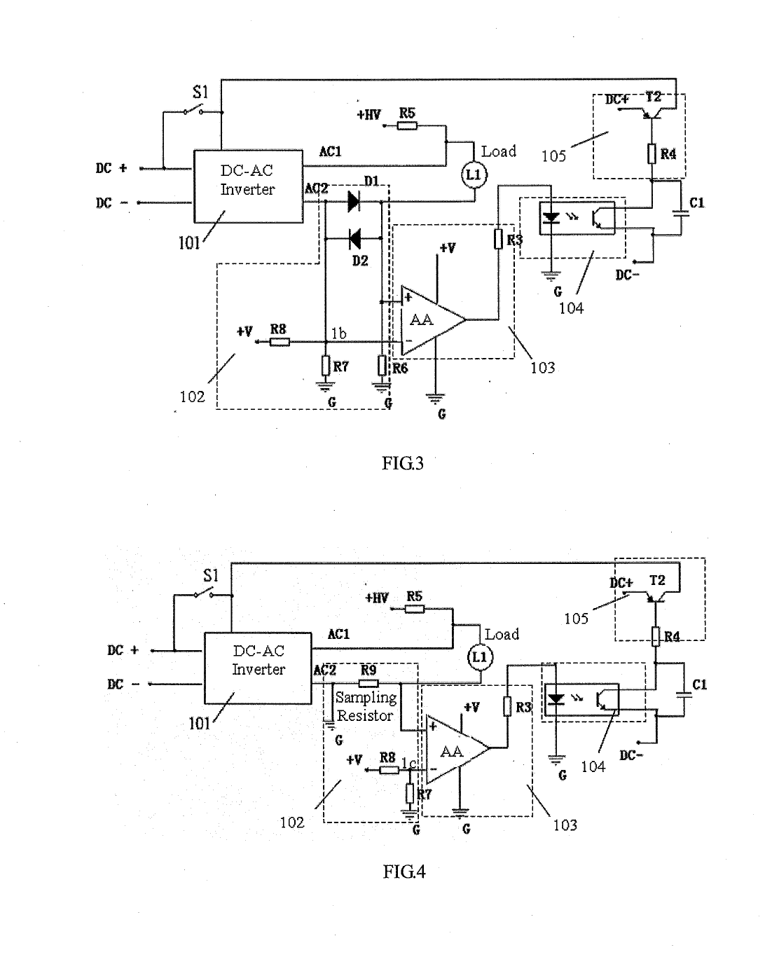

FIG. 3 shows an inverter circuit according to a second preferred embodiment of the present invention. The inverter circuit of this embodiment differs from that of the first preferred embodiment in that: in the second preferred embodiment of the present invention, the sampling circuit includes a first diode D1, a second diode D2, a sixth resistor R6, a seventh resistor R7 and an eighth resistor R8, wherein the first and second diodes D1, D2 are connected in parallel and opposite in polarity to each other and both connected to the second DC input terminal AC2; the sixth resistor R6 is connected between an anode of the second diode D2 and the G point; the anode of the second diode D2 is connected to a positive input terminal of the voltage-current conversion circuit 103; the seventh and eighth resistors R7, R8 are connected in series between the second output terminal of the DC-DC converter power supply (i.e., the low DC voltage +V) and the G point; a node 1b between the seventh and the eighth resistors R7, R8 is connected to both of an anode of the first diode D1 (or a cathode of the second diode D2) and a negative input terminal of the voltage-current conversion circuit 103; moreover, the voltage-current conversion circuit 103 includes an analog amplifier and a third resistor R3, wherein the analog amplifier is connected between the second output terminal of the DC-DC converter power supply (i.e., the low DC voltage +V) and the G point; the positive input terminal of the analog amplifier is connected to the anode of the second diode D2; the negative input terminal of the analog amplifier is connected to the node 1b between the seventh and eighth resistors R7, R8; and an output terminal of the analog amplifier is connected to the isolation circuit 104 via the third resistor R3; moreover, the optocoupler of the isolation circuit 104 has one end (i.e., the end corresponding to the left side of FIG. 3) connected between the voltage-current conversion circuit 103 and the G point and the other end connect in the same way with the first embodiment.

In this embodiment, when a load is connected between the first and second AC output terminals AC1 and AC2, the load current is converted into a sampling voltage which is output thereafter to the positive input terminal of the analog amplifier and generates an optocoupler driving current at the output terminal of the analog amplifier, thereby the optocoupler is turned on. After the optocoupler generates a starting voltage and outputs it to the base of the second transistor T2, the second transistor T2 is turned on and connects the DC voltage provided by the first DC input terminal DC+ to the input terminal of the control circuit of the DC-AC inverter 101, thereby activating the DC-AC inverter 101. Otherwise, when there is no load between the first and second AC output terminals AC1 and AC2, the sampling voltage will not be generated, the analog amplifier will not work, the optocoupler driving current will not be generated, the isolation circuit 104 will not generate the starting voltage, the second transistor T2 will be cut off, the electronic starter switch 105 will control to keep the DC-AC inverter 101 turned off, and thus the total power consumption of the whole system will be equal to that of the DC-DC converter power supply, which is 0.1 W.

FIG. 4 shows an inverter circuit according to a third preferred embodiment of the present invention. The inverter circuit of this embodiment differs from that of the first preferred embodiment in that: in the third preferred embodiment of the present invention, the sampling circuit 102 includes a seventh resistor R7, an eighth resistor R7 and a sampling resistor R9, wherein the sampling resistor R9 is connected between the second AC output terminal AC2 and the load L1 and has one end which is connected to the load L1 connecting to the positive input terminal of the voltage-current conversion circuit 103 and the other end which is connected to the second AC output terminal AC2 connecting to the G point; the seventh and eighth resistors R7, R8 are connected in series between the second output terminal of the DC-DC converter power supply (i.e., the low DC voltage +V) and the point G; a node 1c between the seventh and eighth resistors R7, R8 is connected to the negative input terminal of the voltage-current conversion circuit 103; moreover, the voltage-current conversion circuit 103 includes an analog amplifier and a third resistor R3, wherein the analog amplifier is connected between the second output terminal of the DC-DC converter power supply (i.e., the low DC voltage +V) and the G point; the positive input terminal of the analog amplifier is connected to the sampling resistor R9; the negative input terminal of the analog amplifier is connected to the node 1c between the seventh and eighth resistors R7, R8; and an output terminal of the analog amplifier is connected to the isolation circuit 104 via the third resistor R3.

In this embodiment, when a load is connected between the first and second AC output terminals AC1 and AC2, the load current is converted into a sampling voltage which is output thereafter to the positive input terminal of the analog amplifier and generates an optocoupler driving current at the output terminal of the analog amplifier, thereby the optocoupler is turned on. After the optocoupler generates a starting voltage and outputs it to the base of the second transistor T2, the second transistor T2 is turned on and connects the DC voltage provided by the first DC input terminal DC+ to the input terminal of the control circuit of the DC-AC inverter 101, thereby activating the DC-AC inverter 101. Otherwise, when there is no load between the first and second AC output terminals AC1 and AC2, the sampling voltage will not be generated, the analog amplifier will not work, the optocoupler driving current will not be generated, the isolation circuit 104 will not generate the starting voltage, the second transistor T2 will be cut off, the electronic starter switch 105 will control to keep the DC-AC inverter 101 turned off, and thus the total power consumption of the whole system will be equal to that of the DC-DC converter power supply, which is 0.1 W.

As indicated above, the inverter circuit of the present invention employs a pair of diodes D1 and D2 connected in parallel and opposite in polarity to each other, such that when there is no load, a forward voltage drop provided by the first diode D1 blocks the conductance of the first transistor T1 or the analog amplifier, and when there is a load, the first transistor T1 is turned on due to a forward voltage drop provided by the second diode D2. Moreover, the connection of the first diode D1 and the second diode D2 that are connected opposite in polarity to each other to the second AC output terminal of the DC-AC inverter nearly has no impact on the AC output of the DC-AC inverter. These enable the inverter circuit to have low power consumption (as low as 0.1 W) and to be immediately activated as soon as a load (even smaller than 0.1 W) is connected and to achieve the objective of small load detection when the load is smaller than 0.1 W.

The specific embodiments disclosed above are merely some preferred examples for describing the principles and beneficial effects of the present invention and are not intended to limit the invention in any way. Those skilled in the art can make various modifications and variations without departing from the spirit and scope of the invention. Thus, it is intended that the scope of the present invention is defined by the appended claims.

1. An inverter circuit, comprising:
a DC-AC inverter having a first DC input terminal, a second DC input terminal, a first AC output terminal and a second AC output terminal, the first AC output terminal being connected, via a fifth resistor, to a high DC voltage with respect to a ground (G) point, the first AC output terminal being configured to generate a detection current for indicating whether there is a load when there is no AC output;
a sampling circuit connected to the second AC output terminal for converting a load current to a sampling voltage and output the sampling voltage when there is a load connected between the first AC output terminal and the second AC output terminal;
a voltage-current conversion circuit connected to the sampling circuit for converting the sampling voltage to an optocoupler driving current;
an isolation circuit connected to the voltage-current conversion circuit for isolating a DC input component from an AC output component of the inverter circuit and for generating a starting voltage driven by the optocoupler driving current; and
an electronic starter switch connected to each of the first DC input terminal, the isolation circuit and the voltage-current conversion circuit for controlling an on/off state of the DC-AC inverter under control of the starting voltage.

2. The inverter circuit of claim 1, wherein the sampling circuit includes a first diode, a second diode, a first resistor, a third diode and a DC-DC converter power supply, wherein the first diode and the second diode are connected in parallel and opposite in polarity to each other and both of the first diode and the second diode are connected to the second AC output terminal, wherein the third diode and the first resistor are connected in series between a low DC voltage and the G point, wherein a node between the third diode and the first resistor is connected to an anode of the first diode, and wherein an anode of the second diode generates the sampling voltage.

3. The inverter circuit of claim 2, wherein the voltage-current conversion circuit includes a first transistor, a second resistor and a third resistor, wherein the anode of the second diode is connected to a first base of the first transistor via the second resistor, such that the first transistor is turned on when the sampling voltage is generated, and wherein a first emitter of the first transistor is connected to the isolation circuit via the third resistor to receive the optocoupler driving current.

4. The inverter circuit of claim 3, wherein a second capacitor is connected in parallel to the third diode to stabilize a voltage of the third diode.

5. The inverter circuit of claim 1, wherein the sampling circuit includes a first diode, a second diode, a sixth resistor, a seventh resistor and an eighth resistor, wherein the first diode and the second diode are connected in parallel and opposite in polarity to each other and both of the first diode and the second diode are connected to the second AC output terminal, wherein the sixth resistor is connected between an anode of the second diode and the G point and the anode of the second diode is connected to the voltage-current conversion circuit, wherein the seventh resistor and the eighth resistor are connected in series between a low DC voltage and the G point, and a node between the seventh resistor and the eighth resistor is connected to both of an anode of the first diode and the voltage-current conversion circuit.

6. The inverter circuit of claim 5, wherein the voltage-current conversion circuit includes an analog amplifier and a third resistor, wherein the analog amplifier is connected between the low DC voltage and the G point, and wherein the analog amplifier has a positive input terminal connected to the anode of the second diode, a negative input terminal connected to the node between the seventh resistor and the eighth resistor and an output terminal connected to the isolation circuit via the third resistor.

7. The inverter circuit of claim 1, wherein the sampling circuit includes a seventh resistor, an eighth resistor and a sampling resistor, wherein the sampling resistor is connected between the second AC output terminal and the load and has a first end which is connected to the load connecting to the voltage-current conversion circuit and a second end which is connected to the second AC output terminal connecting to the G point, wherein the seventh resistor and the eighth resistor are connected in series between a low DC voltage and the G point, and wherein a node between the seventh resistor and the eighth resistor is connected to the voltage-current conversion circuit.

8. The inverter circuit of claim 7, wherein the voltage-current conversion circuit includes an analog amplifier and a third resistor, wherein the analog amplifier is connected between the low DC voltage and the G point and wherein the analog amplifier has a positive input terminal connected to the sampling resistor, a negative input terminal connected to the node between the seventh resistor and the eighth resistor and an output terminal connected to the isolation circuit via the third resistor.

9. The inverter circuit of claim 8, wherein both of the high DC voltage and the low DC voltage are generated by a DC-DC converter power supply, and wherein the DC-DC converter power supply is an isolated micro-power converter power supply including a first input terminal, a second input terminal, a first output terminal and a second output terminal, wherein the first output terminal outputs the high DC voltage and the second output terminal outputs the low DC voltage.

10. The inverter circuit of claim 9, wherein the first output terminal outputs a high DC voltage of higher than +100 V, and wherein the second output terminal outputs a low DC voltage of +5 V to +15 V.

11. The inverter circuit of claim 10, wherein a second switch is arranged at the first input terminal of the DC-DC converter power supply for disabling a load detection function when there is no need therefor.

12. The inverter circuit of claim 11, wherein the DC-DC converter power supply has a DC input power of lower than 0.1 W when there is no load.

13. The inverter circuit of claim 1, wherein the isolation circuit includes an optocoupler having a first end connected to the voltage-current conversion circuit and a second end connected between the electronic starter switch and the second DC input terminal, such that when the optocoupler driving current is received at the first end, the second end conducts and generates the starting voltage.

14. The inverter circuit of claim 1, wherein the electronic starter switch includes a second transistor having a second base connected to the isolation circuit, a second emitter connected to the first DC input terminal and a second collector connected to the DC-AC inverter.

15. The inverter circuit of claim 14, wherein the second base of the second transistor is connected to the isolation circuit via a fourth resistor.

16. The inverter circuit of claim 15, wherein a first capacitor is connected in parallel to the isolation circuit between the electronic starter switch and the second DC input terminal to stabilize an operation of the electronic starter switch.

17. The inverter circuit of claim 1, wherein a first switch is arranged at the input terminal of the DC-AC inverter for enabling the DC-AC inverter to be manually turned on when the load detection function is disabled.
